(19) United States
(12) Patent Application Publication
(10) Pub. No.: US 2015/0039849 A1
(43) Pub. Date: Feb. 5, 2015

(54) Multi-Layer Data Storage Virtualization Using a Consistent Data Reference Model

(71) Applicant: Formation Data Systems, Inc., Fremont, CA (US)

(72) Inventor: Mark S. Lewis, Pleasanton, CA (US)

(73) Assignee: Formation Data Systems, Inc., Fremont, CA (US)

(21) Appl. No.: 14/074,584

(22) Filed: Nov. 7, 2013

Related U.S. Application Data
(63) Continuation-in-part of application No. 13/957,849, filed on Aug. 2, 2013.

(51) Int. Cl. G06F 12/08

(52) U.S. Cl. CPC G06F 12/08
USPC 711/203; 711/216

(57) ABSTRACT

A write request that includes a data object is processed. A hash function is executed on the data object, thereby generating a hash value that includes a first portion and a second portion. A hypervisor table is queried with the first portion, thereby obtaining a master storage node identifier. The data object and the hash value are sent to a master storage node associated with the master storage node identifier. At the master storage node, a master table is queried with the second portion, thereby obtaining a storage node identifier. The data object and the hash value are sent from the master storage node to a storage node associated with the storage node identifier.

### RELATED APPLICATION

This application is a continuation-in-part of U.S. patent application Ser. No. 13/957,849, filed Aug. 2, 2013, entitled “High-Performance Distributed Data Storage System with Implicit Content Routing and Data Deduplication.”

### BACKGROUND

1. Technical Field

The present invention generally relates to the field of data storage and, in particular, to a multi-layer virtualized data storage system with a consistent data reference model.

2. Background Information

In a computer system with virtualization, a resource (e.g., processing power, storage space, or networking) is usually dynamically mapped using a reference table. For example, virtual placement of data is performed by creating a reference table that can map what looks like a fixed storage address (the “key” of a table entry) to another address (virtual or actual) where the data resides (the “value” of the table entry).

Storage virtualization enables physical memory (storage) to be mapped to different applications. Typically, a logical address space (which is known to the application) is mapped to a physical address space (which locates the data so that the data can be stored and retrieved). This mapping is usually dynamic so that the storage system can move the data by simply copying the data and remapping the logical address to the new physical address (e.g., by identifying the entry in the reference table where the key is the logical address and then modifying the entry so that the value is the new physical address).

Virtualization can be layered, such that one virtualization scheme is applied on top of another virtualization scheme. For example, in storage virtualization, a file system can provide virtual placement of files on storage arrays, where the storage arrays are also virtualized. In conventional multi-layer virtualized data storage systems, each virtualization scheme operates independently and maintains its own independent mapping (e.g., its own reference table). The data reference models of conventional multi-layer virtualized data storage systems are not consistent. In a non-consistent model, a data reference is translated through a first virtualization layer using a first reference table, and then the translated (i.e., different) data reference is used to determine an address in a second virtualization layer using a second reference table. This is an example of multiple layers of virtualization where the data reference is inconsistent.

### SUMMARY

The above and other issues are addressed by a computer-implemented method, non-transitory computer-readable storage medium, and computer system for storing data using multi-layer virtualization with a consistent data reference model. An embodiment of a method for processing a write request that includes a data object comprises executing a hash function on the data object, thereby generating a hash value that includes a first portion and a second portion. The method further comprises querying a hypervisor table with the first portion, thereby obtaining a master storage node identifier. The method further comprises sending the data object and the hash value to a master storage node associated with the master storage node identifier. The method further comprises at the master storage node, querying a master table with the second portion, thereby obtaining a storage node identifier. The method further comprises sending the data object and the hash value from the master storage node to a storage node associated with the storage node identifier.

An embodiment of a method for processing a write request that includes a data object and a hash value of the data object comprises storing the data object at a storage location. The method further comprises updating a storage node table by adding an entry mapping the hash value to the storage location. The method further comprises outputting a write acknowledgment that includes the hash value.

An embodiment of a medium stores computer program modules for processing a read request that includes an application data identifier, the computer program modules executable to perform steps. The steps comprise querying a virtual volume catalog with the application data identifier, thereby obtaining a hash value of a data object. The hash value includes a first portion and a second portion. The steps further comprise querying a hypervisor table with the first portion, thereby obtaining a master storage node identifier. The steps further comprise sending the hash value to a master storage node associated with the master storage node identifier. The steps further comprise at the master storage node, querying a master table with the second portion, thereby obtaining a storage node identifier. The steps further comprise sending the hash value from the master storage node to a storage node associated with the storage node identifier.

An embodiment of a computer system for processing a read request that includes a hash value of a data object comprises a non-transitory computer-readable storage medium storing computer program modules executable to perform steps. The steps comprise querying a storage node table with the hash value, thereby obtaining a storage location. The steps further comprise retrieving the data object from the storage location.

### BRIEF DESCRIPTION OF THE DRAWINGS

FIG. 1A is a high-level block diagram illustrating an environment for storing data using multi-layer virtualization with a consistent data reference model, according to one embodiment.

FIG. 1B is a high-level block diagram illustrating a simple storage subsystem for use with the environment in FIG. 1A, according to one embodiment.

FIG. 1C is a high-level block diagram illustrating a complex storage subsystem for use with the environment in FIG. 1A, according to one embodiment.

FIG. 2 is a high-level block diagram illustrating an example of a computer for use as one or more of the entities illustrated in FIGS. 1A-1C, according to one embodiment.

FIG. 3 is a high-level block diagram illustrating the hypervisor module from FIG. 1A, according to one embodiment.

FIG. 4 is a high-level block diagram illustrating the storage node module from FIGS. 1B and 1C, according to one embodiment.

FIG. 5 is a sequence diagram illustrating steps involved in processing an application read request using multi-layer virtualization and complex storage subsystems with a consistent data reference model, according to one embodiment.

FIG. 6 is a high-level block diagram illustrating the master module from FIG. 1C, according to one embodiment.

FIG. 7 is a sequence diagram illustrating steps involved in processing an application write request using multi-layer virtualization and simple storage subsystems with a consistent data reference model, according to one embodiment.

FIG. 8 is a sequence diagram illustrating steps involved in processing an application write request using multi-layer virtualization and complex storage subsystems with a consistent data reference model, according to one embodiment.

FIG. 9 is a sequence diagram illustrating steps involved in processing an application read request using multi-layer virtualization and simple storage subsystems with a consistent data reference model, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

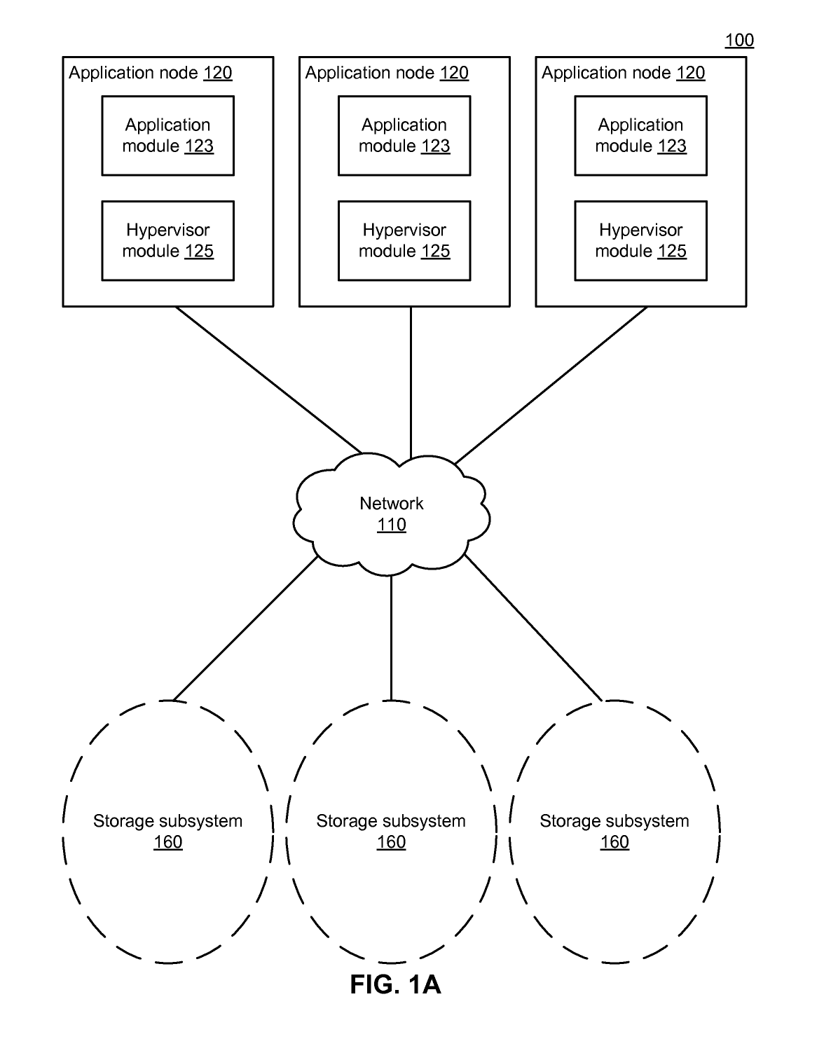

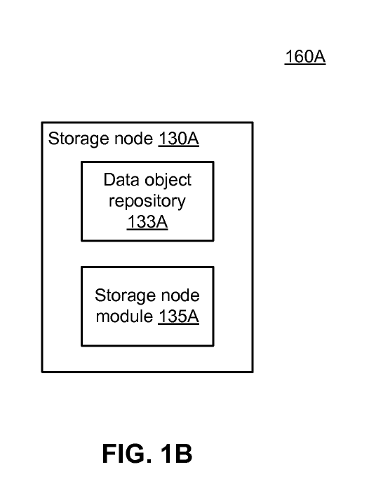

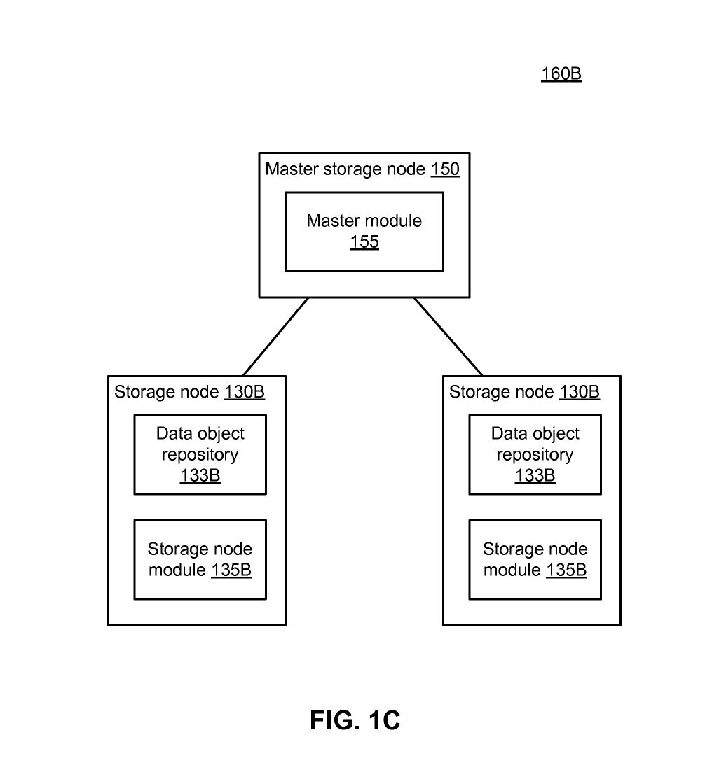

FIG. 1A is a high-level block diagram illustrating an environment 100 for storing data using multi-layer virtualization with a consistent data reference model, according to one embodiment. The environment 100 may be maintained by an enterprise that enables data to be stored using multi-layer virtualization with a consistent data reference model, such as a corporation, university, or government agency. As shown, the environment 100 includes a network 110, multiple application nodes 120, and multiple storage subsystems 160. While three application nodes 120 and three storage subsystems 160 are shown in the embodiment depicted in FIG. 1A, other embodiments can have different numbers of application nodes 120 and/or storage subsystems 160.

The environment 100 stores data objects using multiple layers of virtualization. The first virtualization layer maps a data object from an application node 120 to a storage subsystem 160. One or more additional virtualization layers are implemented by the storage subsystem 160 and are described below with reference to FIGS. 1B and 1C.

The multi-layer virtualization of the environment 100 uses a consistent data reference model. Recall that in a multi-layer virtualized data storage system, one virtualization scheme is applied on top of another virtualization scheme. Each virtualization scheme maintains its own mapping (e.g., its own reference table) for locating data objects. When a multi-layer virtualized data storage system uses an inconsistent data reference model, a data reference is translated through a first virtualization layer using a first reference table, and then the translated (i.e., different) data reference is used to determine an address in a second virtualization layer using a second reference table. In other words, the first reference table and the second reference table use keys based on different data references for the same data object.

When a multi-layer virtualized data storage system uses a consistent data reference model, such as in FIG. 1A, the same data reference is used across multiple distinct virtualization layers for the same data object. For example, in the environment 100, the same data reference is used to route a data object to a storage subsystem 160 and to route a data object within a storage subsystem 160. In other words, all of the reference tables at the various virtualization layers use keys based on the same data reference for the same data object. This data reference, referred to as a “consistent data reference” or “CDR”, identifies a data object and is globally unique across all data objects stored in a particular multi-layer virtualized data storage system that uses a consistent data reference model.

The consistent data reference model simplifies the virtual addressing and overall storage system design while enabling independent virtualization capability to exist at multiple virtualization levels. The consistent data reference model also enables more advanced functionality and reduces the risk that a data object will be accidently lost due to a loss of reference information.

The network 110 represents the communication pathway between the application nodes 120 and the storage subsystems 160. In one embodiment, the network 110 uses standard communications technologies and/or protocols and can include the Internet. Thus, the network 110 can include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 110 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), etc. The data exchanged over the network 110 can be represented using technologies and/or formats including image data in binary form (e.g. Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities on the network 110 can use custom and/or dedicated data communications technologies instead of, or in addition to, the ones described above.

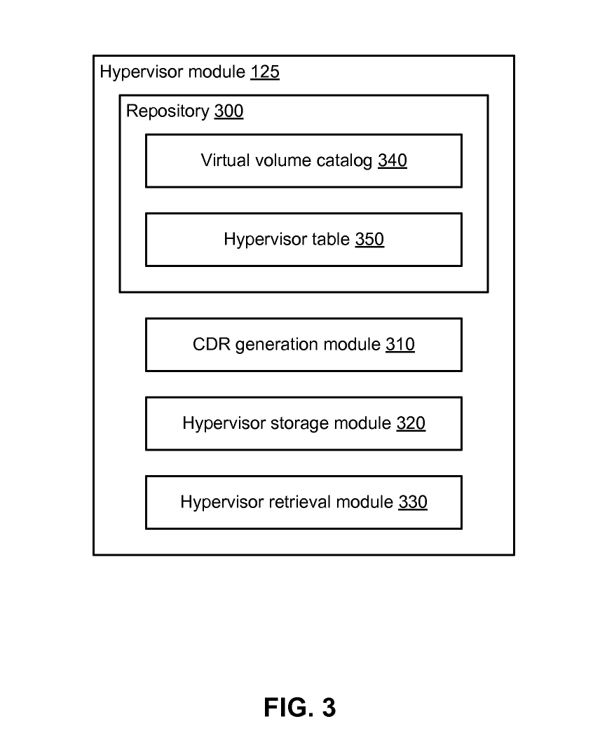

An application node 120 is a computer (or set of computers) that provides standard application functionality and data services that support that functionality. The application node 120 includes an application module 123 and a hypervisor module 125. The application module 123 provides standard application functionality such as serving web pages, archiving data, or data backup/disaster recovery. In order to provide this standard functionality, the application module 123 issues write requests (i.e., requests to store data) and read requests (i.e., requests to retrieve data). The hypervisor module 125 handles these application write requests and application read requests. The hypervisor module 125 is further described below with reference to FIGS. 3 and 7-9.

A storage subsystem 160 is a computer (or set of computers) that handles data requests and stores data objects. The storage subsystem 160 handles data requests received via the network 110 from the hypervisor module 125 (e.g., hypervisor write requests and hypervisor read requests). The storage subsystem 160 is virtualized, using one or more virtualization layers. All of the reference tables at the various virtualization layers within the storage subsystem 160 use keys based on the same data reference for the same data object. Specifically, all of the reference tables use keys based on the consistent data reference (CDR) that is used by the first virtualization layer of the environment 100 (which maps a data object from an application node 120 to a storage subsystem 160). Since all of the reference tables at the various virtualization layers within the environment 100 use keys based on the same data reference for the same data object, the environment 100 stores data using multi-layer virtualization with a consistent data reference model.

Examples of the storage subsystem 160 are described below with reference to FIGS. 1B and 1C. Note that the environment 100 can be used with other storage subsystems 160, beyond those shown in FIGS. 1B and 1C. These other storage subsystems can have, for example, different devices, different numbers of virtualization layers, and/or different types of virtualization layers.

FIG. 1B is a high-level block diagram illustrating a simple storage subsystem 160A for use with the environment 100 in FIG. 1A, according to one embodiment. The simple storage subsystem 160A is a single storage node 130A. The storage node 130A is a computer (or set of computers) that handles data requests, moves data objects, and stores data objects. The storage node 130A is virtualized, using one virtualization layer. That virtualization layer maps a data object from the storage node 130A to a particular location within that storage node 130A, thereby enabling the data object to reside on the storage node 130A. The reference table for that layer uses a key based on the CDR. When simple storage subsystems 160A are used in the environment 100, the environment has two virtualization layers total. Since that environment 100 uses only two virtualization layers, it is characterized as using “simple” multi-layer virtualization.

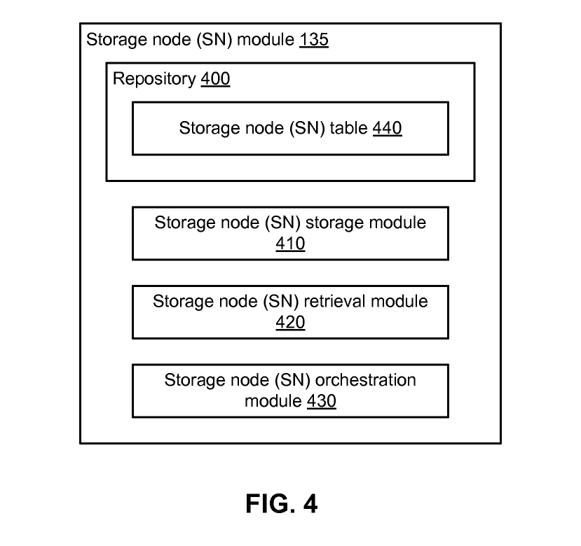

The storage node 130A includes a data object repository 133A and a storage node module 135A. The data object repository 133A stores one or more data objects using any type of storage, such as hard disk, optical disk, flash memory, and cloud. The storage node (SN) module 135A handles data requests received via the network 110 from the hypervisor module 125 (e.g., hypervisor write requests and hypervisor read requests). The SN module 135A also moves data objects around within the data object repository 133A. The SN module 135A is further described below with reference to FIGS. 4, 7, and 9.

FIG. 1C is a high-level block diagram illustrating a complex storage subsystem 160B for use with the environment 100 in FIG. 1A, according to one embodiment. The complex storage subsystem 160B is a storage tree. The storage tree includes one master storage node 150 as the root, which is communicatively coupled to multiple storage nodes 130B. While the storage tree shown in the embodiment depicted in FIG. 1C includes two storage nodes 130B, other embodiments can have different numbers of storage nodes 130B.

The storage tree is virtualized, using two virtualization layers. The first virtualization layer maps a data object from a master storage node 150 to a storage node 130B. The second virtualization layer maps a data object from a storage node 130B to a particular location within that storage node 130B, thereby enabling the data object to reside on the storage node 130B. All of the reference tables for all of the layers use keys based on the CDR. In other words, keys based on the CDR are used to route a data object to a storage node 130B and within a storage node 130B. When complex storage subsystems 160B are used in the environment 100, the environment has three virtualization layers total. Since that environment 100 uses three virtualization layers, it is characterized as using “complex” multi-layer virtualization.

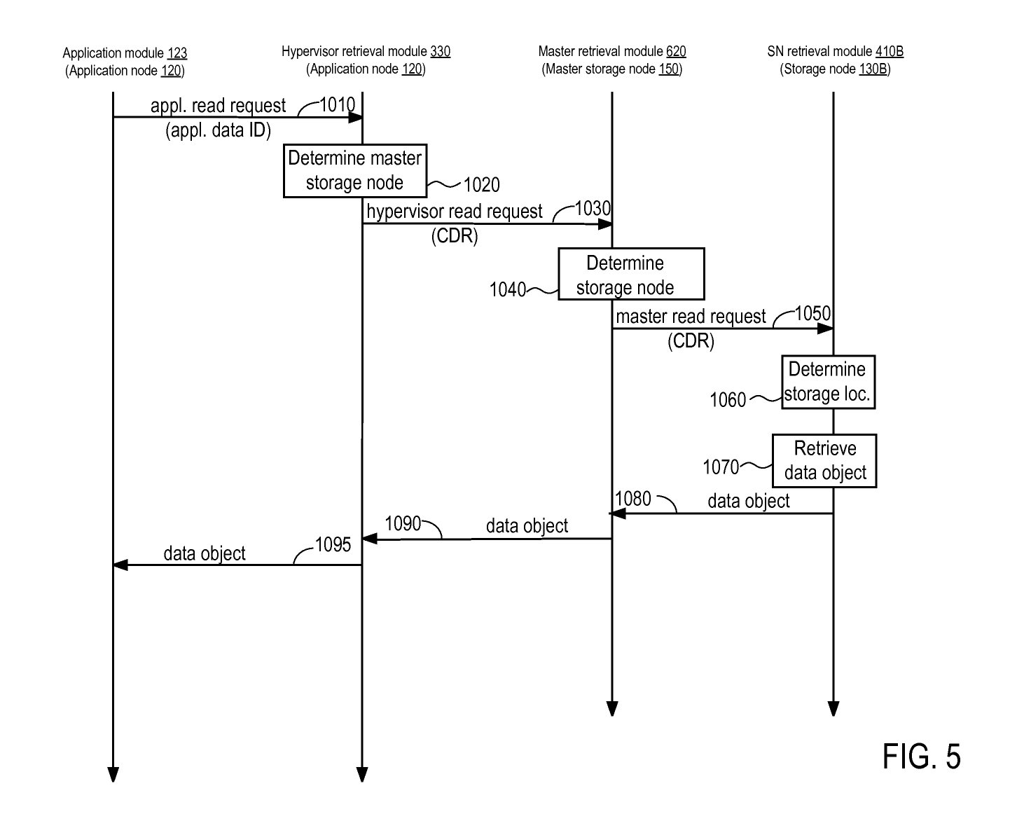

A master storage node 150 is a computer (or set of computers) that handles data requests and moves data objects. The master storage node 150 includes a master module 155. The master module 155 handles data requests received via the network 110 from the hypervisor module 125 (e.g., hypervisor write requests and hypervisor read requests). The master module 155 also moves data objects from one master storage node 150 to another and moves data objects from one storage node 130B to another. The master module 155 is further described below with reference to FIGS. 6, 8, and 5.

A storage node 130B is a computer (or set of computers) that handles data requests, moves data objects, and stores data objects. The storage node 130B in FIG. 1C is similar to the storage node 130A in FIG. 1B, except the storage node module 135B handles data requests received from the master storage node 150 (e.g., master write requests and master read requests). The storage node module 135B is further described below with reference to FIGS. 4, 8, and 5.

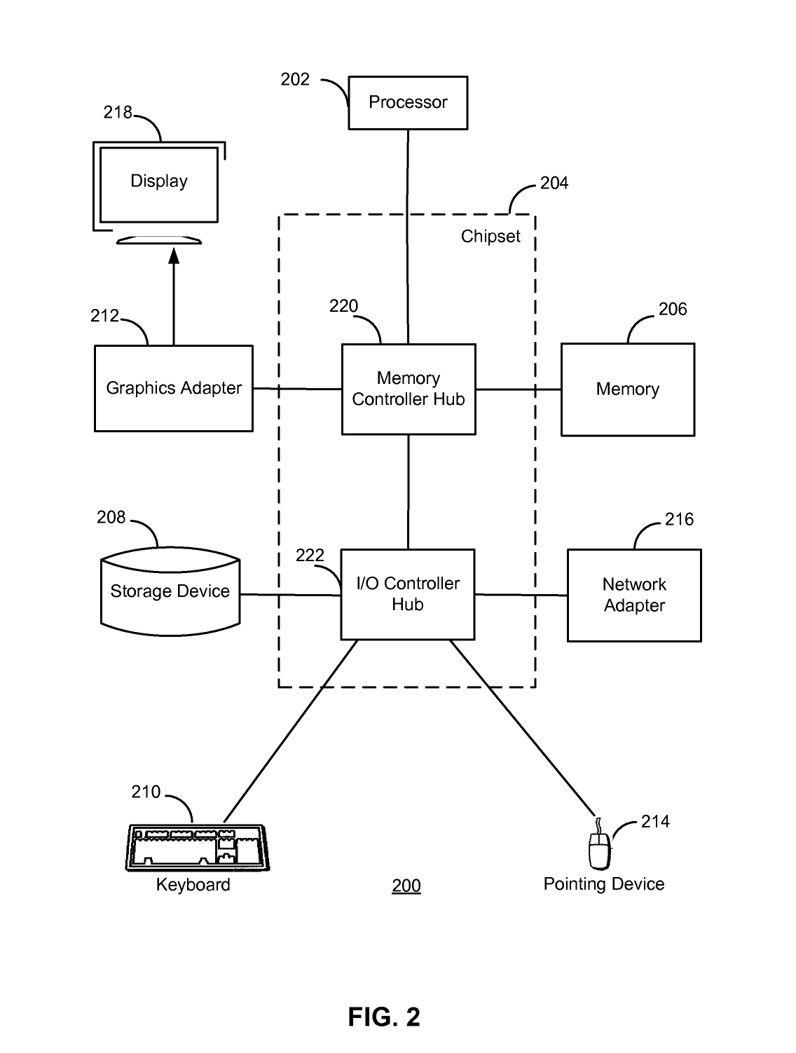

FIG. 2 is a high-level block diagram illustrating an example of a computer 200 for use as one or more of the entities illustrated in FIGS. 1A-1C, according to one embodiment. Illustrated are at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display device 218 is coupled to the graphics adapter 212. A storage device 208, keyboard 210, pointing device 214, and network adapter 216 are coupled to the I/O controller hub 222. Other embodiments of the computer 200 have different architectures. For example, the memory 206 is directly coupled to the processor 202 in some embodiments.

The storage device 208 includes one or more non-transitory computer-readable storage media such as a hard drive, compact disk read-only memory (CD-ROM), DVD, or a solid-state memory device. The memory 206 holds instructions and data used by the processor 202. The pointing device 214 is used in combination with the keyboard 210 to input data into the computer system 200. The graphics adapter 212 displays images and other information on the display device 218. In some embodiments, the display device 218 includes a touch screen capability for receiving user input and selections. The network adapter 216 couples the computer system 200 to the network 110. Some embodiments of the computer 200 have different and/or other components than those shown in FIG. 2. For example, the application node 120 and/or the storage node 130 can be formed of multiple blade servers and lack a display device, keyboard, and other components.

The computer 200 is adapted to execute computer program modules for providing functionality described herein. As used herein, the term “module” refers to computer program instructions and/or other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202.

FIG. 3 is a high-level block diagram illustrating the hypervisor module 125 from FIG. 1A, according to one embodiment. The hypervisor module 125 includes a repository 300, a consistent data reference (CDR) generation module 310, a hypervisor storage module 320, and a hypervisor retrieval module 330. The repository 300 stores a virtual volume catalog 340 and a hypervisor table 350.

The virtual volume catalog 340 stores mappings between application data identifiers and consistent data references (CDRs). One application data identifier is mapped to one CDR. The application data identifier is the identifier used by the application module 123 to refer to the data within the application. The application data identifier can be, for example, a file name, an object name, or a range of blocks. The CDR is used as the primary reference for placement and retrieval of a data object (DO). The CDR identifies a particular DO and is globally unique across all DOs stored in a particular multi-layer virtualized data storage system that uses a consistent data reference model. The same CDR is used to identify the same DO across multiple virtualization layers (specifically, across those layers' reference tables). In the environment 100, the same CDR is used to route a DO to a storage subsystem 160 and to route that same DO within a storage subsystem 160. If the environment 100 uses simple storage subsystems 160A, the same CDR is used to route that same DO within a storage node 130A. If the environment 100 uses complex storage subsystems 160B, the same CDR is used to route a DO to a storage node 130B and within a storage node 130B.

Recall that when a multi-layer virtualized data storage system uses a consistent data reference model, such as in FIG. 1A, the same CDR is used across multiple virtualization layers for the same data object. It follows that all of the reference tables at the various virtualization layers use the same CDR for the same data object.

Although the reference tables use the same CDR, the tables might not use the CDR in the same way. One reference table might use only a portion of the CDR (e.g., the first byte) as a key, where the value is a data location. Since one CDR portion value could be common to multiple full CDR values, this type of mapping potentially assigns the same data location to multiple data objects. This type of mapping would be useful, for example, when the data location is a master storage node (which handles data requests for multiple data objects).

Another mapping might use the entire CDR as a key, where the value is a data location. Since the entire CDR uniquely identifies a data object, this type of mapping does not assign the same data location to multiple data objects. This type of mapping would be useful, for example, when the data location is a physical storage location (e.g., a location on disk).

In one embodiment, a CDR is divided into portions, and different portions are used by different virtualization layers. For example, a first portion of the CDR is used as a key by a first virtualization layer's reference table, a second portion of the CDR is used as a key by a second virtualization layer's reference table, and the entire CDR is used as a key by a third virtualization layer's reference table. In this embodiment, the portions of the CDR that are used as keys by the various reference tables do not overlap (except for the reference table that uses the entire CDR as a key).

In one embodiment, the CDR is a 16-byte value. A first fixed portion of the CDR (e.g., the first four bytes) is used to virtualize and locate a data object across a first storage tier (e.g., multiple master storage nodes 150). A second fixed portion of the CDR (e.g., the next two bytes) is used to virtualize and locate a data object across a second storage tier (e.g., multiple storage nodes 130B associated with one master storage node 150). The entire CDR is used to virtualize and locate a data object across a third storage tier (e.g., physical storage locations within one storage node 130B). This embodiment is summarized as follows:

Bytes 0-3: Used by the hypervisor module 125B for data object routing and location with respect to various master storage nodes 150 (“CDR Locator (CDR-L)”). Since the CDR-L portion of the CDR is used for routing, the CDR is said to support “implicit content routing.”

Bytes 4-5: Used by the master module 155 for data object routing and location with respect to various storage nodes 130B.

Bytes 6-15: Used as a unique identifier for the data object (e.g., for data object placement within a storage node 130B (across individual storage devices) in a similar manner to the data object distribution model used across the storage nodes 130B).

The hypervisor table 350 stores data object placement information (e.g., mappings between consistent data references (CDRs) (or portions thereof) and placement information). For example, the hypervisor table 350 is a reference table that maps CDRs (or portions thereof) to storage subsystems 160. If the environment 100 uses simple storage subsystems 160A, then the hypervisor table 350 stores mappings between CDRs (or portions thereof) and storage nodes 130A. If the environment 100 uses complex storage subsystems 160B, then the hypervisor table 350 stores mappings between CDRs (or portions thereof) and master storage nodes 150. In the hypervisor table 350, the storage nodes 130A or master storage nodes 150 are indicated by identifiers. An identifier is, for example, an IP address or another identifier that can be directly associated with an IP address.

One CDR/portion value is mapped to one or more storage subsystems 160. For a particular CDR/portion value, the identified storage subsystems 160 indicate where a data object (DO) (corresponding to the CDR/portion value) is stored or retrieved. Given a CDR value, the one or more storage subsystems 160 associated with that value are determined by querying the hypervisor table 350 using the CDR/portion value as a key. The query yields the one or more storage subsystems 160 to which the CDR/portion value is mapped (indicated by storage node identifiers or master storage node identifiers). In one embodiment, the mappings are stored in a relational database to enable rapid access.

In one embodiment, the hypervisor table 350 uses as a key a CDR portion that is a four-byte value that can range from [00 00 00 00] to [FF FF FF FF], which provides more than 429 million individual data object locations. Since the environment 100 will generally include fewer than 1000 storage subsystems, a storage subsystem would be allocated many (e.g., thousands of) CDR portion values to provide a good degree of granularity. In general, more CDR portion values are allocated to a storage subsystem 160 that has a larger capacity, and fewer CDR portion values are allocated to a storage subsystem 160 that has a smaller capacity.

The CDR generation module 310 takes as input a data object (DO), generates a consistent data reference (CDR) for that object, and outputs the generated CDR. In one embodiment, the CDR generation module 310 executes a specific hash function on the DO and uses the hash value as the CDR. In general, the hash algorithm is fast, consumes minimal CPU resources for processing, and generates a good distribution of hash values (e.g., hash values where the individual bit values are evenly distributed). The hash function need not be secure. In one embodiment, the hash algorithm is MurmurHash3, which generates a 128-bit value.

Note that the CDR is “content specific,” that is, the value of the CDR is based on the data object (DO) itself. Thus, identical files or data sets will always generate the same CDR value (and, therefore, the same CDR portions). Since data objects (DOs) are automatically distributed across individual storage nodes 130 based on their CDRs, and CDRs are content-specific, then duplicate DOs (which, by definition, have the same CDR) are always sent to the same storage node 130. Therefore, two independent application modules 123 on two different application nodes 120 that store the same file will have that file stored on exactly the same storage node 130 (because the CDRs of the data objects match). Since the same file is sought to be stored twice on the same storage node 130 (once by each application module 123), that storage node 130 has the opportunity to minimize the storage footprint through the consolidation or deduplication of the redundant data (without affecting performance or the protection of the data).

The hypervisor storage module 320 takes as input an application write request, processes the application write request, and outputs a hypervisor write acknowledgment. The application write request includes a data object (DO) and an application data identifier (e.g., a file name, an object name, or a range of blocks).

In one embodiment, the hypervisor storage module 320 processes the application write request by: 1) using the CDR generation module 310 to determine the DO's CDR; 2) using the hypervisor table 350 to determine the one or more storage subsystems 160 associated with the CDR; 3) sending a hypervisor write request (which includes the DO and the CDR) to the associated storage subsystem(s); 4) receiving a write acknowledgement from the storage subsystem(s) (which includes the DO's CDR); and 5) updating the virtual volume catalog 340 by adding an entry mapping the application data identifier to the CDR. If the environment 100 uses simple storage subsystems 160A, then steps (2)-(4) concern storage nodes 130A. If the environment 100 uses complex storage subsystems 160B, then steps (2)-(4) concern master storage nodes 150.

In one embodiment, updates to the virtual volume catalog 340 are also stored by one or more storage subsystems 160 (e.g., the same group of storage subsystems 160 that is associated with the CDR). This embodiment provides a redundant, non-volatile, consistent replica of the virtual volume catalog 340 data within the environment 100. In this embodiment, when a storage hypervisor module 125 is initialized or restarted, the appropriate copy of the virtual volume catalog 340 is loaded from a storage subsystem 160 into the hypervisor module 125. In one embodiment, the storage subsystems 160 are assigned by volume ID (i.e., by each unique storage volume), as opposed to by CDR. In this way, all updates to the virtual volume catalog 340 will be consistent for any given storage volume.

The hypervisor retrieval module 330 takes as input an application read request, processes the application read request, and outputs a data object (DO). The application read request includes an application data identifier (e.g., a file name, an object name, or a range of blocks).

In one embodiment, the hypervisor retrieval module 330 processes the application read request by: 1) querying the virtual volume catalog 340 with the application data identifier to obtain the corresponding CDR; 2) using the hypervisor table 350 to determine the one or more storage subsystems 160 associated with the CDR; 3) sending a hypervisor read request (which includes the CDR) to one of the associated storage subsystem(s); and 4) receiving a data object (DO) from the storage subsystem 160.

Regarding steps (2) and (3), recall that the hypervisor table 350 can map one CDR/portion to multiple storage subsystems 160. This type of mapping provides the ability to have flexible data protection levels allowing multiple data copies. For example, each CDR/portion can have a Multiple Data Location (MDA) to multiple storage subsystems 160 (e.g., four storage subsystems). The MDA is noted as Storage Subsystem (x) where x=1-4. SS1 is the primary data location, SS2 is the secondary data location, and so on. In this way, a hypervisor retrieval module 330 can tolerate a failure of a storage subsystem 160 without management intervention. For a failure of a storage subsystem 160 that is “SS1” to a particular set of CDRs/portions, the hypervisor retrieval module 330 will simply continue to operate.

The MDA concept is beneficial in the situation where a storage subsystem 160 fails. A hypervisor retrieval module 330 that is trying to read a particular data object will first try SS1 (the first storage subsystem 160 listed in the hypervisor table 350 for a particular CDR/portion value). If SS1 fails to respond, then the hypervisor retrieval module 330 automatically tries to read the data object from SS2, and so on. By having this resiliency built in, good system performance can be maintained even during failure conditions.

Note that if the storage subsystem 160 fails, the data object can be retrieved from an alternate storage subsystem 160. For example, after the hypervisor read request is sent in step (3), the hypervisor retrieval module 330 waits a short period of time for a response from the storage subsystem 160. If the hypervisor retrieval module 330 hits the short timeout window (i.e., if the time period elapses without a response from the storage subsystem 160), then the hypervisor retrieval module 330 interacts with a different one of the determined storage subsystems 160 to fulfill the hypervisor read request.

Note that the hypervisor storage module 320 and the hypervisor retrieval module 330 use the CDR/portion (via the hypervisor table 350) to determine where the data object (DO) should be stored. If a DO is written or read, the CDR/portion is used to determine the placement of the DO (specifically, which storage subsystem(s) 160 to use). This is similar to using an area code or country code to route a phone call. Knowing the CDR/portion for a DO enables the hypervisor storage module 320 and the hypervisor retrieval module 330 to send a write request or read request directly to a particular storage subsystem 160 (even when there are thousands of storage subsystems) without needing to access another intermediate server (e.g., a directory server, lookup server, name server, or access server). In other words, the routing or placement of a DO is “implicit” such that knowledge of the DO's CDR makes it possible to determine where that DO is located (i.e., with respect to a particular storage subsystem 160). This improves the performance of the environment 100 and negates the impact of having a large scale-out system, since the access is immediate, and there is no contention for a centralized resource.

FIG. 4 is a high-level block diagram illustrating the storage node module 135 from FIGS. 1B and 1C, according to one embodiment. The storage node (SN) module 135 includes a repository 400, a storage node storage module 410, a storage node retrieval module 420, and a storage node orchestration module 430. The repository 400 stores a storage node table 440.

The storage node (SN) table 440 stores mappings between consistent data references (CDRs) and actual storage locations (e.g., on hard disk, optical disk, flash memory, and cloud). One CDR is mapped to one actual storage location. For a particular CDR, the data object (DO) associated with the CDR is stored at the actual storage location.

The storage node (SN) storage module 410 takes as input a write request, processes the write request, and outputs a storage node (SN) write acknowledgment.

In one embodiment, where the SN module 135A is part of a simple storage subsystem 160A, the SN storage module 410A takes as input a hypervisor write request, processes the hypervisor write request, and outputs a SN write acknowledgment. The hypervisor write request includes a data object (DO) and the DO's CDR. In one embodiment, the SN storage module 410A processes the hypervisor write request by: 1) storing the DO; and 2) updating the SN table 440A by adding an entry mapping the CDR to the actual storage location. The SN write acknowledgment includes the CDR.

In one embodiment, where the SN module 135B is part of a complex storage subsystem 160B, the SN storage module 410B takes as input a master write request, processes the master write request, and outputs a SN write acknowledgment. The master write request includes a data object (DO) and the DO's CDR. In one embodiment, the SN storage module 410B processes the master write request by: 1) storing the DO; and 2) updating the SN table 440B by adding an entry mapping the CDR to the actual storage location. The SN write acknowledgment includes the CDR.

The storage node (SN) retrieval module 420 takes as input a read request, processes the read request, and outputs a data object (DO).

In one embodiment, where the SN module 135A is part of a simple storage subsystem 160A, the SN retrieval module 420A takes as input a hypervisor read request, processes the hypervisor read request, and outputs a data object (DO). The hypervisor read request includes a CDR. In one embodiment, the SN retrieval module 420A processes the hypervisor read request by: 1) using the SN table 440A to determine the actual storage location associated with the CDR; and 2) retrieving the DO stored at the actual storage location.

In one embodiment, where the SN module 135B is part of a complex storage subsystem 160B, the SN retrieval module 420B takes as input a master read request, processes the master read request, and outputs a data object (DO). The master read request includes a CDR. In one embodiment, the SN retrieval module 420B processes the master read request by: 1) using the SN table 440B to determine the actual storage location associated with the CDR; and 2) retrieving the DO stored at the actual storage location.

The storage node (SN) orchestration module 430 performs storage allocation and tuning within the storage node 130. Specifically, the SN orchestration module 430 moves data objects around within the data object repository 133 (e.g., to defragment the memory). Recall that the SN table 440 stores mappings (i.e., associations) between CDRs and actual storage locations. The aforementioned movement of a data object is indicated in the SN table 440 by modifying a specific CDR association from one actual storage location to another. After the relevant data object has been copied, the SN orchestration module 430 updates the SN table 440 to reflect the new allocation.

In one embodiment, the SN orchestration module 430 also performs storage allocation and tuning among the various storage nodes 130. Storage nodes 130 can be added to (and removed from) the environment 100 dynamically. Adding (or removing) a storage node 130 will increase (or decrease) linearly both the capacity and the performance of the overall environment 100. When a storage node 130 is added, data objects are redistributed from the previously-existing storage nodes 130 such that the overall load is spread evenly across all of the storage nodes 130, where “spread evenly” means that the overall percentage of storage consumption will be roughly the same in each of the storage nodes 130. In general, the SN orchestration module 430 balances base capacity by moving CDR segments from the most-used (in percentage terms) storage nodes 130 to the least-used storage nodes 130 until the environment 100 becomes balanced.

In one embodiment, the SN orchestration module 430 also insures that a subsequent failure or removal of a storage node 130 will not cause any other storage nodes to become overwhelmed. This is achieved by insuring that the alternate/redundant data from a given storage node 130 is also distributed across the remaining storage nodes.

CDR assignment changes (i.e., modifying a CDR's storage node association from one node to another) can occur for a variety of reasons. If a storage node 130 becomes overloaded or fails, other storage nodes 130 can be assigned more CDRs to rebalance the overall environment 100. In this way, moving small ranges of CDRs from one storage node 130 to another causes the storage nodes to be “tuned” for maximum overall performance.

Since each CDR represents only a small percentage of the total storage, the reallocation of CDR associations (and the underlying data objects) can be performed with great precision and little impact on capacity and performance. For example, in an environment with 100 storage nodes, a failure (and reconfiguration) of a single storage node would require the remaining storage nodes to add only ˜1% additional load. Since the allocation of data objects is done on a percentage basis, storage nodes 130 can have different storage capacities. Data objects will be allocated such that each storage node 130 will have roughly the same percentage utilization of its overall storage capacity. In other words, more CDR segments will typically be allocated to the storage nodes 130 that have larger storage capacities.

If the environment 100 uses simple storage subsystems 160A, then the hypervisor table 350A stores mappings (i.e., associations) between CDRs and storage nodes 130A. The aforementioned movement of a data object is indicated in the hypervisor table 350A by modifying a specific CDR association from one storage node 130A to another. After the relevant data object has been copied, the SN orchestration module 430A updates the hypervisor table 350A to reflect the new allocation. Data objects are grouped by individual CDRs such that an update to the hypervisor table 350A in each hypervisor module 125A can change the storage node(s) associated with the CDRs. Note that the existing hypervisor modules 125A will continue to operate properly using the older version of the hypervisor table 350A until the update process is complete. This proper operation enables the overall hypervisor table update process to happen over time while the environment 100 remains fully operational.

If the environment 100 uses complex storage subsystems 160B, then the master table 640 stores mappings (i.e., associations) between CDRs and storage nodes 130B. The aforementioned movement of a data object is indicated in the master table 640 by modifying a specific CDR association from one storage node 130B to another. (Note that if the origination storage node 130B and the destination storage node 130B are not associated with the same master storage node 150, then the hypervisor table 350B must also be modified.) After the relevant data object has been copied, the SN orchestration module 430B updates the master table 640 to reflect the new allocation. (If the origination storage node 130B and the destination storage node 130B are not associated with the same master storage node 150, then the SN orchestration module 430B also updates the hypervisor table 350B.) Data objects are grouped by individual CDRs such that an update to the master table 640 in each master module 155 can change the storage node(s) associated with the CDRs. Note that the existing master storage nodes 150 will continue to operate properly using the older version of the master table 640 until the update process is complete. This proper operation enables the overall master table update process to happen over time while the environment 100 remains fully operational.

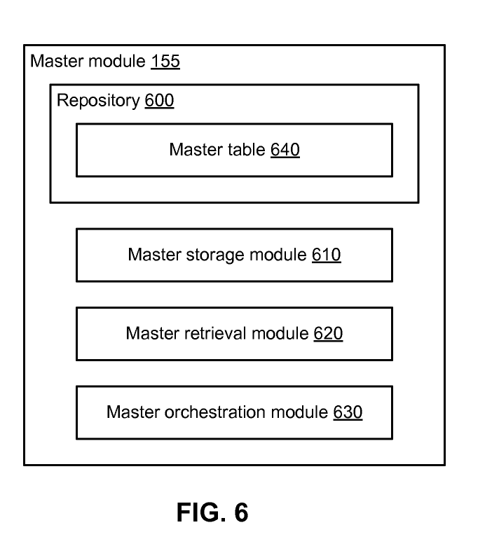

FIG. 6 is a high-level block diagram illustrating the master module 155 from FIG. 1C, according to one embodiment. The master module 155 includes a repository 600, a master storage module 610, a master retrieval module 620, and a master orchestration module 630. The repository 600 stores a master table 640.

The master table 640 stores mappings between consistent data references (CDRs) (or portions thereof) and storage nodes 130B. One CDR is mapped to one or more storage nodes 130B (indicated by storage node identifiers). A storage node identifier is, for example, an IP address or another identifier that can be directly associated with an IP address. For a particular CDR, the identified storage nodes 130B indicate where a data object (DO) (corresponding to the CDR) is stored or retrieved. In one embodiment, the mappings are stored in a relational database to enable rapid access.

The master storage module 610 takes as input a hypervisor write request, processes the hypervisor write request, and outputs a master write acknowledgment. The hypervisor write request includes a data object (DO) and the DO's CDR. In one embodiment, the master storage module 610 processes the hypervisor write request by: 1) using the master table 640 to determine the one or more storage nodes 130B associated with the CDR; 2) sending a master write request (which includes the DO and the CDR) to the associated storage node(s); and 3) receiving a write acknowledgement from the storage node(s) (which includes the DO's CDR). The master write acknowledgment includes the CDR.

The master retrieval module 620 takes as input a hypervisor read request, processes the hypervisor read request, and outputs a data object (DO). The hypervisor read request includes a CDR. In one embodiment, the master retrieval module 620 processes the hypervisor read request by: 1) using the master table 640 to determine the one or more storage nodes 130B associated with the CDR; and 2) sending a master read request (which includes the CDR) to the associated storage node(s); and 3) receiving the DO.

Regarding steps (2) and (3), recall that the master table 640 can map one CDR/portion to multiple storage nodes 130B. This type of mapping provides the ability to have flexible data protection levels allowing multiple data copies. For example, each CDR/portion can have a Multiple Data Location (MDA) to multiple storage nodes 130B (e.g., four storage subsystems). The MDA is noted as Storage Node (x) where x=1-4. SN1 is the primary data location, SN2 is the secondary data location, and so on. In this way, a master retrieval module 620 can tolerate a failure of a storage node 130B without management intervention. For a failure of a storage node 130B that is “SN1” to a particular set of CDRs/portions, the master retrieval module 620 will simply continue to operate.

The MDA concept is beneficial in the situation where a storage node 130B fails. A master retrieval module 620 that is trying to read a particular data object will first try SN1 (the first storage node 130B listed in the master table 640 for a particular CDR/portion value). If SN1 fails to respond, then the master retrieval module 620 automatically tries to read the data object from SN2, and so on. By having this resiliency built in, good system performance can be maintained even during failure conditions.

Note that if the storage node 130B fails, the data object can be retrieved from an alternate storage node 130B. For example, after the master read request is sent in step (2), the master retrieval module 620 waits a short period of time for a response from the storage node 130B. If the master retrieval module 620 hits the short timeout window (i.e., if the time period elapses without a response from the storage node 130B), then the master retrieval module 620 interacts with a different one of the determined storage nodes 130B to fulfill the master read request.

Note that the master storage module 610 and the master retrieval module 620 use the CDR/portion (via the mater table 640) to determine where the data object (DO) should be stored. If a DO is written or read, the CDR/portion is used to determine the placement of the DO (specifically, which storage node(s) 130B to use). This is similar to using an area code or country code to route a phone call. Knowing the CDR/portion for a DO enables the master storage module 610 and the master retrieval module 620 to send a write request or read request directly to a particular storage node 130B (even when there are thousands of storage nodes) without needing to access another intermediate server (e.g., a directory server, lookup server, name server, or access server). In other words, the routing or placement of a DO is “implicit” such that knowledge of the DO's CDR makes it possible to determine where that DO is located (i.e., with respect to a particular storage node 130B). This improves the performance of the environment 100 and negates the impact of having a large scale-out system, since the access is immediate, and there is no contention for a centralized resource.

The master orchestration module 630 performs storage allocation and tuning among the various storage nodes 130B. This allocation and tuning among storage nodes 130B is similar to that described above with reference to allocation and tuning among storage nodes 130, except that after the relevant data object has been copied, the master orchestration module 630 updates the master table 640 to reflect the new allocation. (If the origination storage node 130B and the destination storage node 130B are not associated with the same master storage node 150, then the master orchestration module 630 also updates the hypervisor table 350B.) Only one master storage node 150 within the environment 100 needs to include the master orchestration module 630. However, in one embodiment, multiple master storage nodes 150 within the environment 100 (e.g., two master storage nodes) include the master orchestration module 630. In that embodiment, the master orchestration module 630 runs as a redundant process.

In summary, a data object that is moved within a storage node 130, remapped among storage nodes 130, or remapped among master storage nodes 150 continues to be associated with the same CDR. In other words, the data object's CDR does not change. The environment 100 enables a particular CDR (or a portion thereof) to be remapped to different values (e.g., locations) at each virtualization layer. The unchanging CDR can be used to enhance redundancy (data protection) and/or performance.

If a data object is moved within a storage node 130, then the storage node table 440 is updated to indicate the new location. There is no need to modify the hypervisor table 350 (or the master table 640, if present). If a data object is remapped among storage nodes 130A, then the hypervisor table 350A is updated to indicate the new location. The storage node table 440A of the destination storage node is also modified. If a data object is remapped among storage nodes 130B, then the master table 640 is updated to indicate the new location. The storage node table 440B of the destination storage node is also modified. There is no need to modify the hypervisor table 350B. If a data object is remapped among master storage nodes 150, then the hypervisor table 350B is updated to indicate the new location. The storage node table 440B of the destination storage node and the master table 640 of the destination master storage node are also modified.

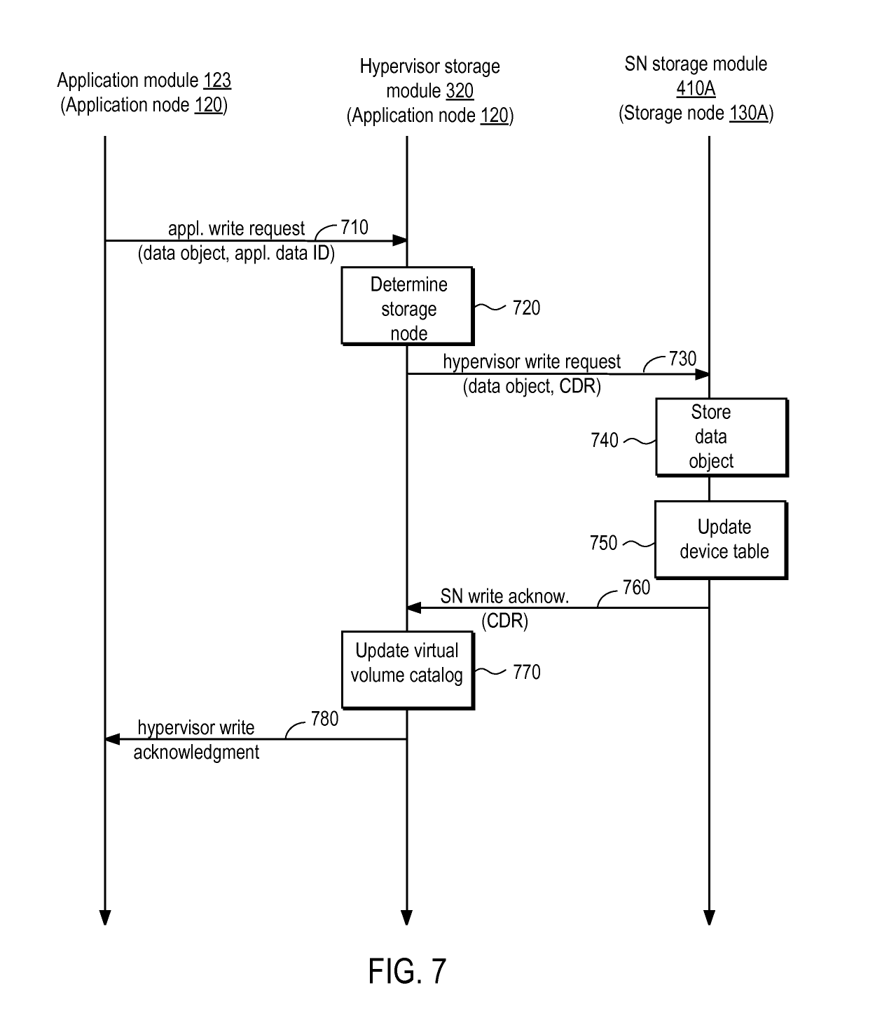

FIG. 7 is a sequence diagram illustrating steps involved in processing an application write request using multi-layer virtualization and simple storage subsystems 160A with a consistent data reference model, according to one embodiment. In step 710, an application write request is sent from an application module 123 (on an application node 120) to a hypervisor module 125 (on the same application node 120). The application write request includes a data object (DO) and an application data identifier (e.g., a file name, an object name, or a range of blocks). The application write request indicates that the DO should be stored in association with the application data identifier.

In step 720, the hypervisor storage module 320 (within the hypervisor module 125 on the same application node 120) determines one or more storage nodes 130A on which the DO should be stored. For example, the hypervisor storage module 320 uses the CDR generation module 310 to determine the DO's CDR and uses the hypervisor table 350 to determine the one or more storage nodes 130A associated with the CDR.

In step 730, a hypervisor write request is sent from the hypervisor module 125 to the one or more storage nodes 130A (specifically, to the SN modules 135A on those storage nodes 130A). The hypervisor write request includes the data object (DO) that was included in the application write request and the DO's CDR. The hypervisor write request indicates that the SN module 135A should store the DO.

In step 740, the SN storage module 410A stores the DO.

In step 750, the SN storage module 410A updates the SN table 440 by adding an entry mapping the DO's CDR to the actual storage location where the DO was stored (in step 740).

In step 760, a SN write acknowledgment is sent from the SN storage module 410A to the hypervisor module 125. The SN write acknowledgment includes the CDR.

In step 770, the hypervisor storage module 320 updates the virtual volume catalog 340 by adding an entry mapping the application data identifier (that was included in the application write request) to the CDR.

In step 780, a hypervisor write acknowledgment is sent from the hypervisor storage module 320 to the application module 123.

Note that while CDRs are used by the hypervisor storage module 320 and the SN storage module 410A, CDRs are not used by the application module 123. Instead, the application module 123 refers to data using application data identifiers (e.g., file names, object name, or ranges of blocks).

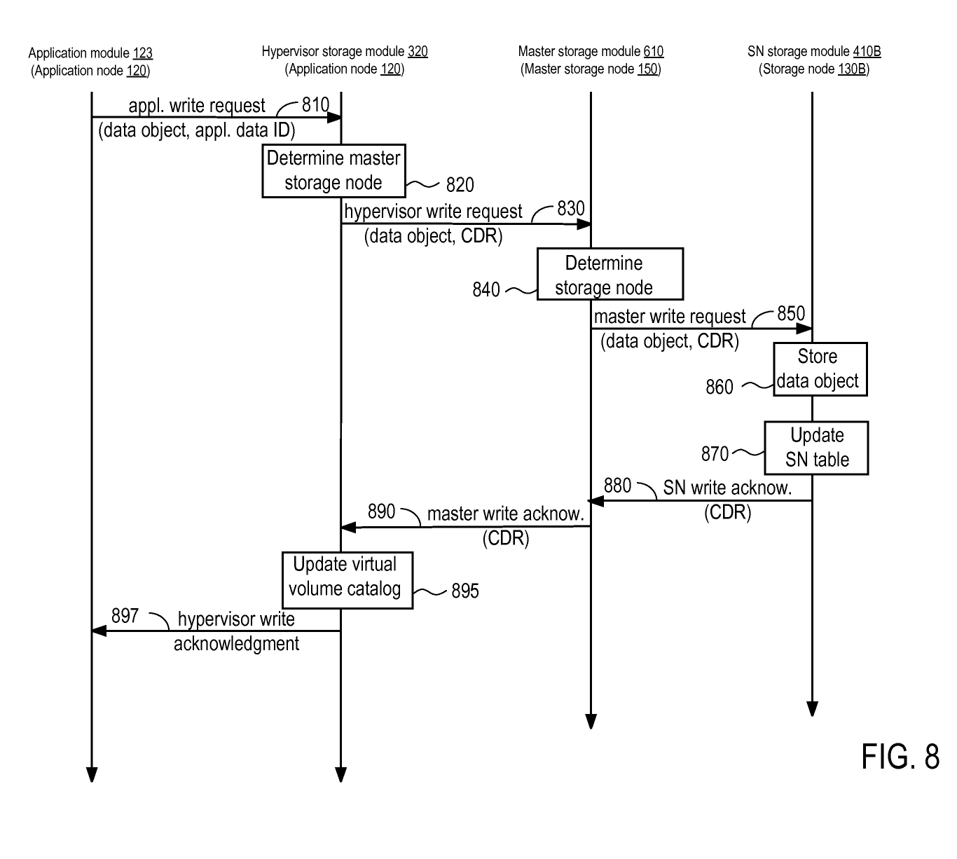

FIG. 8 is a sequence diagram illustrating steps involved in processing an application write request using multi-layer virtualization and complex storage subsystems with a consistent data reference model, according to one embodiment. In step 810, an application write request is sent from an application module 123 (on an application node 120) to a hypervisor module 125 (on the same application node 120). The application write request includes a data object (DO) and an application data identifier (e.g., a file name, an object name, or a range of blocks). The application write request indicates that the DO should be stored in association with the application data identifier.

In step 820, the hypervisor storage module 320 (within the hypervisor module 125 on the same application node 120) determines one or more master storage nodes 150 on which the DO should be stored. For example, the hypervisor storage module 320 uses the CDR generation module 310 to determine the DO's CDR and uses the hypervisor table 350 to determine the one or more master storage nodes 150 associated with the CDR.

In step 830, a hypervisor write request is sent from the hypervisor module 125 to the one or more master storage nodes 150 (specifically, to the master modules 155 on those master storage nodes 150). The hypervisor write request includes the data object (DO) that was included in the application write request and the DO's CDR. The hypervisor write request indicates that the master storage node 150 should store the DO.

In step 840, the master storage module 610 (within the master module 155 on the master storage node 150) determines one or more storage nodes 130B on which the DO should be stored. For example, the master storage module 610 uses the master table 640 to determine the one or more storage nodes 130B associated with the CDR.

In step 850, a master write request is sent from the master module 155 to the one or more storage nodes 130B (specifically, to the SN modules 135B on those storage nodes 130B). The master write request includes the data object (DO) and the DO's CDR that were included in the hypervisor write request. The master write request indicates that the storage node 130B should store the DO.

In step 860, the SN storage module 410B stores the DO.

In step 870, the SN storage module 410B updates the SN table 440 by adding an entry mapping the DO's CDR to the actual storage location where the DO was stored (in step 860).

In step 880, a SN write acknowledgment is sent from the SN storage module 410B to the master module 155. The SN write acknowledgment includes the CDR.

In step 890, a master write acknowledgment is sent from the master storage module 610 to the hypervisor module 125. The master write acknowledgment includes the CDR.

In step 895, the hypervisor storage module 320 updates the virtual volume catalog 340 by adding an entry mapping the application data identifier (that was included in the application write request) to the CDR.

In step 897, a hypervisor write acknowledgment is sent from the hypervisor storage module 320 to the application module 123.

Note that while CDRs are used by the hypervisor storage module 320, the master storage module 610, and the SN storage module 410B, CDRs are not used by the application module 123. Instead, the application module 123 refers to data using application data identifiers (e.g., file names, object name, or ranges of blocks).

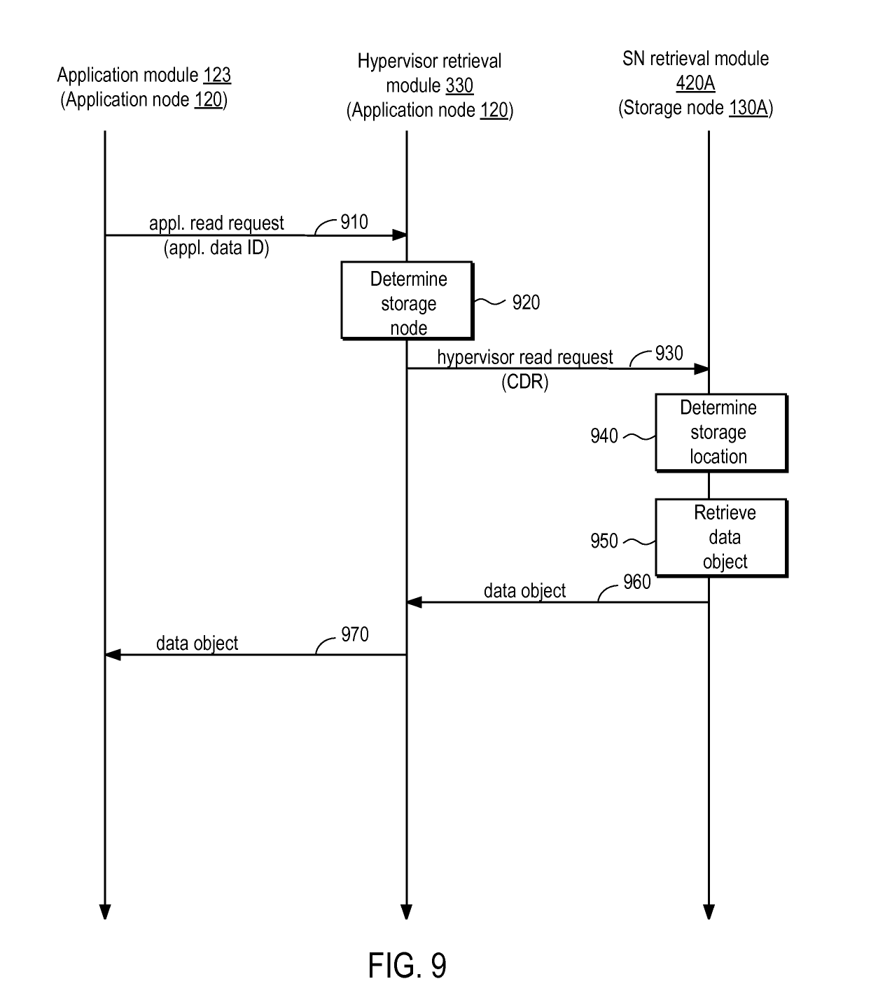

FIG. 9 is a sequence diagram illustrating steps involved in processing an application read request using multi-layer virtualization and simple storage subsystems 160A with a consistent data reference model, according to one embodiment. In step 910, an application read request is sent from an application module 123 (on an application node 120) to a hypervisor module 125 (on the same application node 120). The application read request includes an application data identifier (e.g., a file name, an object name, or a range of blocks). The application read request indicates that the data object (DO) associated with the application data identifier should be returned.

In step 920, the hypervisor retrieval module 330 (within the hypervisor module 125 on the same application node 120) determines one or more storage nodes 130A on which the DO associated with the application data identifier is stored. For example, the hypervisor retrieval module 330 queries the virtual volume catalog 340 with the application data identifier to obtain the corresponding CDR and uses the hypervisor table 350 to determine the one or more storage nodes 130A associated with the CDR.

In step 930, a hypervisor read request is sent from the hypervisor module 125 to one of the determined storage nodes 130A (specifically, to the SN module 135A on that storage node 130A). The hypervisor read request includes the CDR that was obtained in step 920. The hypervisor read request indicates that the SN module 135A should return the DO associated with the CDR.

In step 940, the SN retrieval module 420A (within the SN module 135A on the storage node 130A) uses the SN table 440 to determine the actual storage location associated with the CDR.

In step 950, the SN retrieval module 420A retrieves the DO stored at the actual storage location (determined in step 940).

In step 960, the DO is sent from the SN retrieval module 420A to the hypervisor module 125.

In step 970, the DO is sent from the hypervisor retrieval module 330 to the application module 123.

Note that while CDRs are used by the hypervisor retrieval module 330 and the SN retrieval module 420A, CDRs are not used by the application module 123. Instead, the application module 123 refers to data using application data identifiers (e.g., file names, object name, or ranges of blocks).

FIG. 5 is a sequence diagram illustrating steps involved in processing an application read request using multi-layer virtualization and complex storage subsystems with a consistent data reference model, according to one embodiment. In step 1010, an application read request is sent from an application module 123 (on an application node 120) to a hypervisor module 125 (on the same application node 120). The application read request includes an application data identifier (e.g., a file name, an object name, or a range of blocks). The application read request indicates that the data object (DO) associated with the application data identifier should be returned.

In step 1020, the hypervisor retrieval module 330 (within the hypervisor module 125 on the same application node 120) determines one or more master storage nodes 150 on which the DO associated with the application data identifier is stored. For example, the hypervisor retrieval module 330 queries the virtual volume catalog 340 with the application data identifier to obtain the corresponding CDR and uses the hypervisor table 350 to determine the one or more master storage nodes 150 associated with the CDR.

In step 1030, a hypervisor read request is sent from the hypervisor module 125 to one of the determined master storage nodes 150 (specifically, to the master module 155 on that master storage node 150). The hypervisor read request includes the CDR that was obtained in step 1020. The hypervisor read request indicates that the master storage node 150 should return the DO associated with the CDR.

In step 1040, the master retrieval module 620 (within the master module 155 on the master storage node 150) determines one or more storage nodes 130B on which the DO associated with the CDR is stored. For example, the master retrieval module 620 uses the master table 640 to determine the one or more storage nodes 130B associated with the CDR.

In step 1050, a master read request is sent from the master module 155 to one of the determined storage nodes 130B (specifically, to the SN module 135B on that slave storage node 140). The master read request includes the CDR that was included in the hypervisor read request. The master read request indicates that the storage node 130B should return the DO associated with the CDR.

In step 1060, the SN retrieval module 420B (within the SN module 135B on the storage node 130B) uses the SN table 440 to determine the actual storage location associated with the CDR.

In step 1070, the SN retrieval module 420B retrieves the DO stored at the actual storage location (determined in step 1060).

In step 1080, the DO is sent from the SN retrieval module 420B to the master module 155.

In step 1090, the DO is sent from the master retrieval module 620 to the hypervisor module 125.

In step 1095, the DO is sent from the hypervisor retrieval module 330 to the application module 123.

Note that while CDRs are used by the hypervisor retrieval module 330, the master retrieval module 620, and the SN retrieval module 420A, CDRs are not used by the application module 123. Instead, the application module 123 refers to data using application data identifiers (e.g., file names, object name, or ranges of blocks).

The above description is included to illustrate the operation of certain embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A method for processing a write request that includes a data object, the method comprising:
executing a hash function on the data object, thereby generating a hash value that includes a first portion and a second portion;
querying a hypervisor table with the first portion, thereby obtaining a master storage node identifier;
sending the data object and the hash value to a master storage node associated with the master storage node identifier;
at the master storage node, querying a master table with the second portion, thereby obtaining a storage node identifier; and
sending the data object and the hash value from the master storage node to a storage node associated with the storage node identifier.

2. The method of claim 1, wherein querying the hypervisor table with the first portion results in obtaining both the master storage node identifier and a second master storage node identifier, the method further comprising:
sending the data object and the hash value to a master storage node associated with the second master storage node identifier.

3. The method of claim 1, wherein querying the master table with the second portion results in obtaining both the storage node identifier and a second storage node identifier, the method further comprising:
sending the data object and the hash value from the master storage node to a storage node associated with the second storage node identifier.

4. The method of claim 1, wherein the write request further includes an application data identifier, the method further comprising:
updating a virtual volume catalog by adding an entry mapping the application data identifier to the hash value.

5. The method of claim 4, wherein the application data identifier comprises a file name, an object name, or a range of blocks.

6. The method of claim 1, wherein a length of the hash value is sixteen bytes.

7. The method of claim 1, wherein a length of the first portion is four bytes.

8. The method of claim 1, wherein a length of the second portion is two bytes.

9. The method of claim 1, wherein the master storage node identifier comprises an Internet Protocol (IP) address.

10. The method of claim 1, wherein the storage node identifier comprises an Internet Protocol (IP) address.

11. A method for processing a write request that includes a data object and a hash value of the data object, the method comprising:
storing the data object at a storage location;
updating a storage node table by adding an entry mapping the hash value to the storage location; and
outputting a write acknowledgment that includes the hash value.

12. A non-transitory computer-readable storage medium storing computer program modules for processing a read request that includes an application data identifier, the computer program modules executable to perform steps comprising:
querying a virtual volume catalog with the application data identifier, thereby obtaining a hash value of a data object, wherein the hash value includes a first portion and a second portion;
querying a hypervisor table with the first portion, thereby obtaining a master storage node identifier;
sending the hash value to a master storage node associated with the master storage node identifier;
at the master storage node, querying a master table with the second portion, thereby obtaining a storage node identifier; and
sending the hash value from the master storage node to a storage node associated with the storage node identifier.

13. The computer-readable storage medium of claim 12, wherein the steps further comprise receiving the data object.

14. The computer-readable storage medium of claim 12, wherein querying the hypervisor table with the first portion results in obtaining both the master storage node identifier and a second master storage node identifier, and wherein the steps further comprise:
waiting for a response from the master storage node associated with the master storage node identifier; and
responsive to no response being received within a specified time period, sending the hash value to a master storage node associated with the second master storage node identifier.

15. The computer-readable storage medium of claim 12, wherein querying the master table with the second portion results in obtaining both the storage node identifier and a second storage node identifier, and wherein the steps further comprise:
at the master storage node, waiting for a response from the storage node associated with the storage node identifier; and
responsive to no response being received within a specified time period, sending the hash value from the master storage node to a storage node associated with the second storage node identifier.

16. A computer system for processing a read request that includes a hash value of a data object, the system comprising:
a non-transitory computer-readable storage medium storing computer program modules executable to perform steps comprising:
querying a storage node table with the hash value, thereby obtaining a storage location; and
retrieving the data object from the storage location; and
a computer processor for executing the computer program modules.

17. The system of claim 16, wherein the steps further comprise outputting the data object.
